(19) United States
(12) Patent Application Publication
(10) Pub. No.: US 2011/0315767 A1
(43) Pub. Date: Dec. 29, 2011

(54) Automatically adjustable gun sight

(76) Inventor: John L. Lowrance, Princeton, NJ (US)

(21) Appl. No.: 13/135,158

(22) Filed: Jun. 27, 2011

Related U.S. Application Data
(60) Provisional application No. 61/398,602, filed on Jun. 28, 2010.

(51) Int. Cl. G06G 7/80

(52) U.S. Cl. 235/404; 235/409

(57) ABSTRACT

Apparatus for viewing, imaging and processing the trace of a high speed bullet aimed at a desired target including apparatus to replay and review the trace image to more accurately determine the path of the bullet and its actual or intended point of impact. The processed information can be used to determine, or directly measure, the “miss-distance” between the desired target point and what is, or would be, the impact point of the bullet. The miss-distance information can be used to aid automatically re-aiming the weapon (e.g., rifle, gun) firing the bullet to compensate for the miss-distance.

This application claims the benefit of U.S. Provisional Application Ser. No. 61/398,602 filed Jun. 28, 2010 whose teachings are incorporated herein by reference in their entirety.

### BACKGROUND OF THE INVENTION

The present invention relates to firearm weapons systems which include apparatus for sensing and displaying the “trace” (trajectory) of high velocity projectiles (e.g., bullets) which generate atmospheric turbulence during their travel and to the processing of trace information to control the operation of firearm weapons systems.

An example of a problem in the operation of firearms from which high velocity projectiles are being fired is as follows. When a sniper (or any rifleman) aims and shoots a bullet from his rifle at a target, the goal is a first round “kill” of the targeted object. However, the impact point of the rifle bullet aimed at the target is a function (in addition to the gun aim) of the actual muzzle velocity, the distance to the target, wind velocity vector along the trajectory and other secondary effects including the angular “spin” induced by the rifling of the rifle's (gun) barrel bore. Consequently, the factors discussed above often cause the target to be partly, or wholly, missed. These factors are particularly significant at long range and where the target is frequently human torso size, subtending an angle of only 0.3 milliradians at 1000 yards.

Typically, a sniper is part of a sniper team which includes a spotter member whose task includes looking at the bullet's trace going towards the target after the sniper pulls the trigger of the rifle. The spotter's task is to perceive the atmospheric disturbance (trace) created by a high velocity bullet's travel through the atmosphere and from this ascertain, where the first round lands. On the basis of this visual information, the spotter tells the sniper to shift his aim to the right or left, or up or down by an indicated amount.

A problem with the prior system is that the bullet's passage is so quick that the spotter cannot be absolutely certain of his observation of the trace. Note that a 7.62 mm round's retained velocity at 700 meter range is 1466 feet/sec and the bullet takes approximately 1 second to reach its target. Thus, the spotter has only a fraction of a second to view the trace of the bullet and to then evaluate the trace he observed. As a result, his sightings are typically blurry and his conclusions as to the impact point may not be very accurate.

Another problem with the prior art system is that the spotter needs to communicate his observed trace information to the sniper. As noted, the information transmitted by the spotter may not be accurate. Also, communicating the ascertained information by the spotter to the sniper may take several seconds. Still further, there is room for error in the spotter's transmission of information and in the sniper's reception. In addition to the errors resulting from the limited ability of a human observer, the time required, and taken, for transmitting these communications and the time needed to respond gives the targeted individual an opportunity to change position (“duck”).

An object of the invention is to resolve the problems discussed above.

### SUMMARY OF THE INVENTION

According to one aspect of the invention, imaging apparatus is provided which can capture images of the trace of a bullet (i.e., atmospheric perturbation created by a high speed bullet and its trajectory) including means for processing and analyzing the images of the bullet's trace during its flight to a target. The processed information can, among others, be used (by a spotter and sniper) to replay and review the trace image to more accurately determine the path of the bullet and its point of impact.

The processed information can also be used to determine or directly measure the “miss distance” between the desired target point and what is, or would be, the impact point of the bullet as indicated by the trace observation. The miss-distance information can be used to calculate a reticle position adjustment on the weapon (e.g., rifle, gun) that would compensate for this miss distance.

According to another aspect of the invention trace information is used to automate the process of re-aiming a weapon (e.g., rifle, gun) for a second round (and any subsequent rounds). Doing so eliminates human intervention, human response time and associated human errors. An advantage of automating the re-aiming process is that the target has less time to react (“duck”) before the second round arrives.

A system embodying the invention includes a gun barrel for firing a bullet at a target and a spotter scope for focusing on the target and for viewing the trace of a bullet fired from the gun barrel towards the target. A digital television camera is coupled to the spotter scope for capturing images of the bullet's trace as it travels towards the target. An image processing means is coupled to the digital camera for receiving the images of the bullet's travel and in response thereto calculating and determining any miss-distance indicated between the captured images of the bullet's travel and the target.

The term gun as used herein and in the appended claims includes any muzzle or breech loaded projectile firing weapon having a “gun barrel”, or tube, through which a controlled explosion or rapid expansion of gases are released in order to propel a projectile (e.g., bullet) out of the end of the tube at supersonic velocity. The term “gun” as used thus includes any rifle (a firearm designed to be fired from the shoulder) as well as guns mounted on vehicles such as tanks.

A weapon (e.g., a rifle) embodying the invention may include a telescopic sight to aid in aiming at a target. The telescopic sight may include a reticle which can be adjusted by activating selected actuators. Information, such as the “miss distance” information from an image processor, may be communicated, via cable or wirelessly, to the actuators controlling the reticle positioning without requiring the involvement of the person aiming/firing the weapon. This enables the rapid and automatic adjustment of the alignment (bore-sight) of the weapon's telescopic sight to the gun tube.

Any suitable reticle may be used in the telescopic sight and any suitable mechanism may be used to control the adjustment and positioning of the reticle.

Systems embodying the invention may also include apparatus for displaying (to a Spotter and/or Sniper) the calculated position of the bullet trace relative to the spotting scope crosshair designating target as the bullet nears the target.

Systems embodying the invention may also include means for using the miss distance information as an input to a fire control computer system of a weapon such as a tank gun.

In systems embodying the invention, the imaging apparatus may be designed to capture images of the bullet itself, in addition to the atmospheric “trace” of the bullet, or as an alternative to the trace. The captured images may then be processed in a similar manner to the processing of the trace images.

### BRIEF DESCRIPTION OF THE DRAWINGS

In the accompanying drawings like reference characters denote like components, and

FIG. 1a is a schematic diagram of an automatically adjustable gun sight system, showing a television camera viewing the target area through a spotting scope in accordance with the invention;

FIG. 1b is a schematic diagram of another automatically adjustable gun sight, system embodying the invention;

FIG. 2 is a drawing of a display showing a selected target point and an actual or indicated bullet impact point;

FIG. 3 is a graph of transmission characteristics of atmospheric conditions; and

FIG. 4 is a block diagram of a video image processor for use in practicing the invention.

### DETAILED DESCRIPTION OF THE INVENTION

As shown in the figures, systems embodying the invention include apparatus (100, 100a) for: (a) imaging (observing), viewing and processing the trace (i.e., the trajectory and/or turbulence) of a high speed (e.g., supersonic) bullet shot from a weapon (rifle or gun) and traveling to a target; and (b) responsive to the processed information for automatically communicating needed adjustment for aiming the next (second round) bullet at the target.

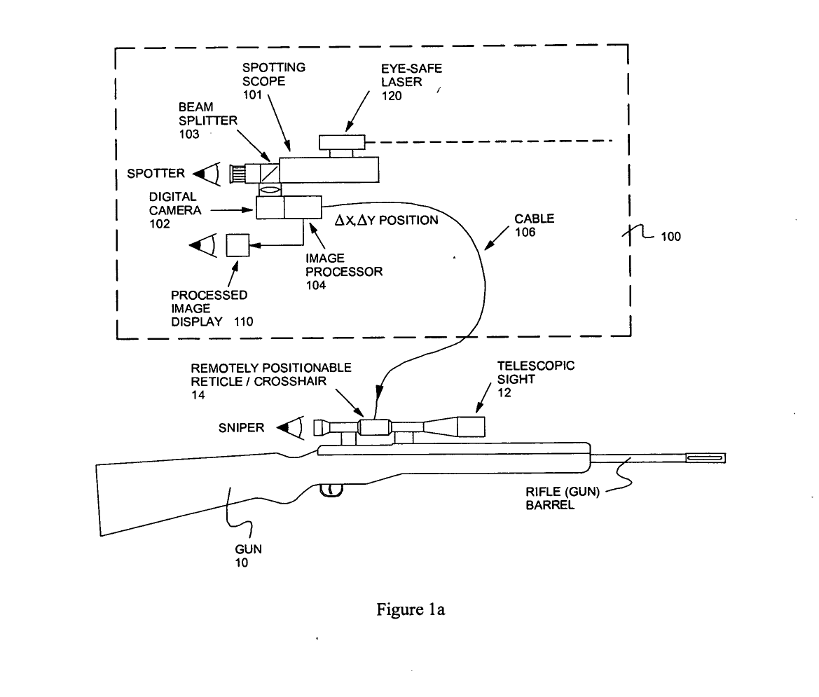

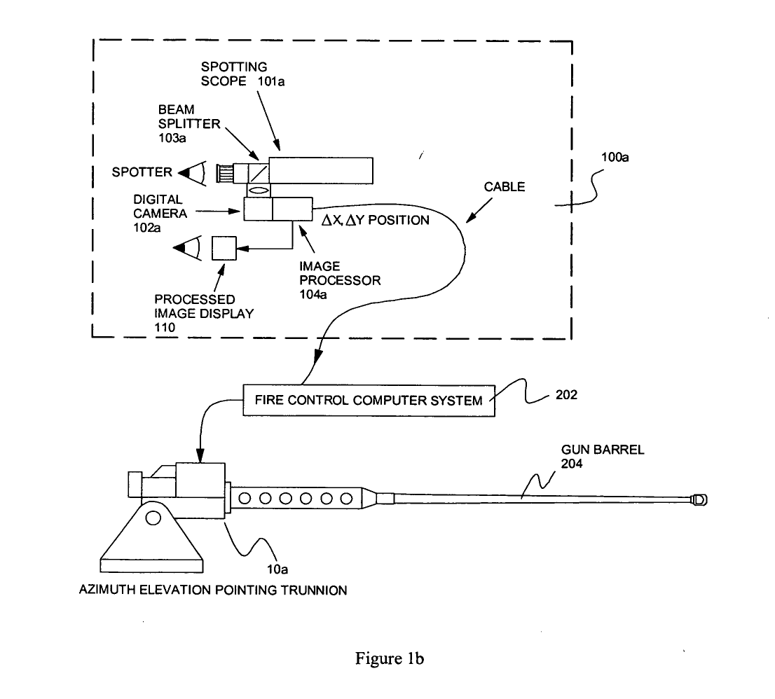

FIG. 1a is a schematic drawing of an automatically adjustable gun sight system to automate the functions previously performed by a “human” Spotter. The system of FIG. 1a includes a rifle 10 on which is mounted a telescopic sight 12 which may be used to aim the rifle at a target. In contrast to the prior art, the telescopic sight 12 includes a reticle/cross hair remotely positioning module 14 which can be adjusted remotely. By way of example, the rifle may be intended for use by a sniper.

The system shown in FIG. 1a also includes a spotting scope 101 on which is mounted an eye safe laser 120 which can be used to illuminate the target. The spotting scope 101 is focused on, and used by, the spotter to identify the target of interest. The spotting scope is coupled via an optical beam splitter 103 to a television type digital camera 102. The beam splitter 103 also enables a viewer (e.g., a Spotter) to view the scene being projected onto and into the digital camera 102. A digital image-processor 104 is coupled to the camera 102. The image processor 104 is programmed to analyze and process the video information seen by the spotting scope. The processor 104 enables the viewing and reviewing of successive video frames and the comparison of successive frames to detect a bullet's trace. The processor 104 can also be programmed to calculate the location of the bullet's path in the region near the target.

In FIG. 1a, the image processor 104 also outputs an image to a display monitor 110 showing the computed (or actual) position of a bullet's trace relative to the target (crosshair). This may be viewed by a spotter and a sniper. [Note: This feature enables aiming correction even with rifles that do not have a telescopic sight with the remotely adjustable reticle mechanism described above.] The video images can be played back, in an instant replay mode, at an optimized frame rate that is better matched to the perception time constant of the human observer. It also provides a means of recording each “shot” for replay and analysis in training the sniper and documenting the event.

In FIG. 1a, the processor 104 is shown connected via a cable 106 to the reticle control positioning module 14 on telescopic sight 12 of the rifle. The cable 106 is used to transmit signals to actuators located in module 14 to shift the reticle alignment relative to the rifle barrel/bore. The actuators in module 14 are used to adjust the rifle's aim of the second round to compensate for the influence of crosswind, range error, bullet velocity, etc. The adjustments are done automatically. No human communication is needed to adjust the aiming of the second bullet. In FIG. 1a, a cable 106 is shown to transmit signals from the processor 104 to module 14. However, it should be appreciated that signals can be transmitted from the processor 104 to the actuators in module 14 wirelessly (e.g., via rf transmission or even optically).

In practice, the spotting scope 101 (and its associated equipment) may be mounted on a tripod fixed in space so as to remain focused on the target and to also view the trace of the bullets being shot by the rifle towards the target. Thus, the spotting scope may be positioned at a point overlooking the shoulder of a sniper, or at any suitable point, to enable the camera and the spotter to view the target and the bullet's trace as it travels towards the target.

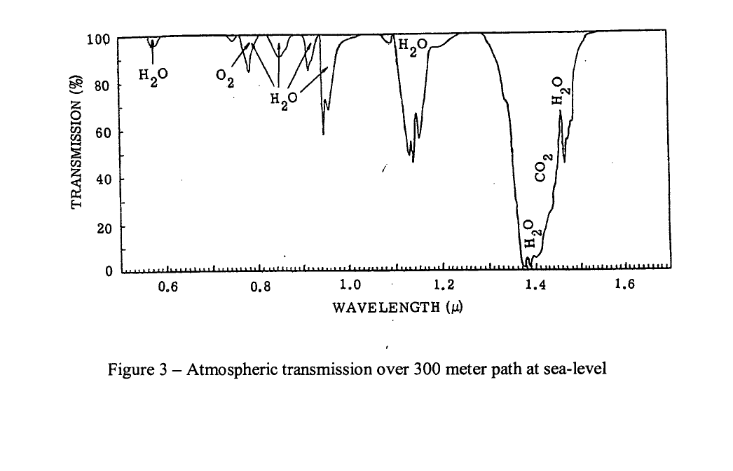

In contrast to the prior art which relies on a spotter identifying the bullet trace in the field of view of the spotting scope 101 and mentally judging where the bullet will hit relative to the target and then telling the Sniper how much to adjust his aim, systems embodying the invention have the following advantages:
a) The temporal response of the eye is 100-200 milliseconds, depending on the ambient light, and significantly slower than the 60 field per second standard scan rate television camera. This longer exposure time of the human eye reduces the contrast of the trace against the background for those trace's whose duration is shorter than the time constant of the eye. This lower contrast makes it more difficult for the Spotter to perceive the trace and interpret its position relative to the target and tell the Sniper how to adjust his aim.
b) The higher sensitivity of the digital television cameras in the near infrared region, compared to the human eye, improves the detection of traces illuminated by low ambient light (which is rich in the near infrared) and when operating with infrared illuminators. As already noted, as the bullet travels through space it creates a turbulence (wake) which is visible. The visibility of the trace may be affected by atmospheric conditions illustrated in FIG. 3. However, the viewing equipment (in contrast to the human eye) may be designed to compensate for variations in atmospheric conditions.

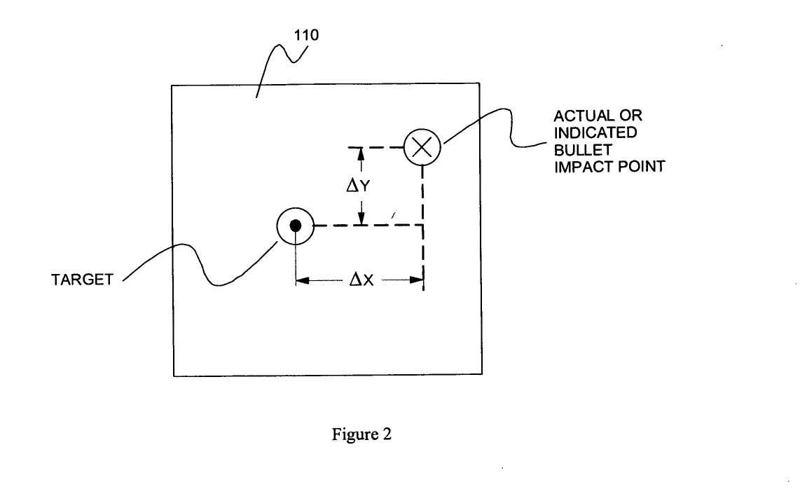

In accordance with this invention, the images viewed through the spotting scope 101 are transmitted onto and viewed by a television type camera 102 which can digitize the video signals. The video output of the digital camera 102 is “inputted” to a digital image processor module 104. The combination of the camera 102 and processor 104 can view the flight of a bullet and can be programmed to compare successive frames. This combination is used to detect the optical signature (trace) of a high velocity bullet and calculates its position relative to the spotting scope crosshair focused on a target. The combination is programmed to detect and locate, in the field of view, the optical signature “trace” associated with the passage of a high velocity bullet through the atmosphere. Thus, after a first round is shot through the rifle, the bullet's optical signature, referred to by the sniper community as the bullet's “trace”, is acquired by a digital camera sharing the spotting scope with a spotter. These digital images are analyzed by the image processor 104 to detect the trace of the bullet and determine its position (offset) relative to the spotting scope's crosshair centered on the sniper's target, as shown in FIG. 2.

FIG. 2 illustrates that: (a) the target may be constantly viewed and (b) the actual or indicated impact point of the bullet also may be viewed and/or determined. The offset (delta x, delta y) can be determined and/or displayed in many different ways. The bullet and or its trace can thus be detected and located relative to the target; providing the information needed to automatically/remotely adjust the aim of the sniper rifle by changing its crosshair position relative to the gun bore (changing the bore sight). Views of the target as the bullet (or its trace) nears and/or hits the target can be generated continuously and viewed continuously and reviewed on a frame by frame basis.

This offset information may be transmitted (sent) to: (a) a display 110 as shown in FIG. 2; and/or (b) to the rifle scope's reticle module 14 to shift its reticle position such that the rifle's aim of the next shot is shifted to account for the errors causing the first shot to miss the target.

The reticle associated with the rifle's telescopic sight is adjustable (moveable) and is remotely controlled to shift its position so as to dynamically change the boresight of the telescopic sight to the rifle bore. The primary application is to automatically adjust the boresight of the rifle to its telescopic sight, based on information acquired from observing the miss-distance of the preceding shot, and to facilitate this adjustment quickly enough to allow a second shot to be fired as soon as the sniper can reload and re-aim at the target.

The reticle is a network of fine lines, dots, cross hairs in the focal plane of the eyepiece of an optical instrument. A telescopic sight contains a “reticle” to facilitate a Sniper adjusting his aim to account for range and crosswinds and all other factors discussed above. In accordance with the invention, the reticle/crosshair of a rifle's telescopic sight can be remotely controlled to move in the x position and/or the y position to dynamically change the bore sighting of the rifle to its telescopic sight. Based on information acquired from observing a preceding shot, the bore sight of the rifle (or gun) is automatically adjusted to its telescopic sight. The automatic adjustment enables a subsequent (e.g., second) shot to be fired as soon as the sniper recovers from the recoil of the first shot and re-aims at the same point on the target as the previous round. Due to the automatic adjustments of the reticle, the sniper is not necessarily aware that the reticle has shifted relative to the rifle barrel/bore.

### Remotely Positioned Reticle

Any number of reticles which are remotely adjustable can be used to practice the invention. For example, a movable reticle can be implemented using a liquid crystal display. However, the reticle in sniper rifle scopes and similar aiming devices preferably consist of very fine (narrow) lines that challenge the state of the art in liquid crystal displays. Another implementation is to mechanically shift the x, y position of an etched glass plate containing the reticle. This may be implemented using electro-mechanical mechanisms similar to those employed in image stabilization during the exposure interval of commercially available digital cameras. These actuators incrementally move a solid state image sensor in the x and y direction to follow the motion of an optical image. Similar electro-mechanical actuators can be employed to move the etched glass plate containing the reticle or an optical element such as a transparent glass plate whose tilting effects a lateral shift in the optical line of sight.

In accordance with the invention, apparatus is provided to automatically detect and measure the “offset” location of a first bullet relative to a target, (in the plane of the target) and automatically cause a change to the rifle's telescopic sight in a fraction of a second. The “off-set” information can be obtained by processing television images with a micro-processor (which is appropriately programmed or dedicated) and associated electronic circuitry and sent (via a small flexible cable or wirelessly) to (miniature) actuators in the rifle's telescopic sight to shift the rifle's scope's reticle in the x and y directions to correct the aiming of the next round.

Thus, a method for providing a “Closed-Loop Fire Control” (CLFC) system, as shown in FIG. 1a, includes:

1—Attaching a digital camera to a sniper spotting scope;
2—Feeding the camera digitized video output to a digital-image-processor;
3—Processing the digital images, in near real time, to identify the “trace” image and determine its location (offset) relative to the aim point (crosshair);
4—Sending these offset coordinates (via a cable or wirelessly) to actuators in a rifle's telescopic sight; and
5—Activating the actuators to shift the position (X,Y) of the telescopic sight reticle to change the boresight of the telescopic sight relative to rifle barrel/bore. This shift in boresight is transparent to the sniper who would repeat his aiming of the first round in firing the second round.

In the context of a sniper-spotter operation, an automated closed-loop fire control (CLFC) system embodying the invention sets the Spotter “out of the loop” for the second round and the shift in rifle scope crosshair relative to the rifle bore is automatic and transparent to the Sniper as well. After recovering from recoil, the sniper repositions the now electronically repositioned crosshair on the target and pulls the trigger. Since the detection and measurement of the first bullet's trace can be accomplished by the image-processor in a fraction of a second and the rifle scope crosshair also adjusted in a fraction of a second, the next round can be fired as quickly as the sniper can recover from the recoil and reposition the crosshair-sight on the target. The sniper is unaware of the cross hair being shifted, firing the second round as he would if the closed loop fire control were not involved.

A first round hit could be indicated by the image processor module generating a distinct motion of the reticle/crosshair that would tell the sniper there is no need to fire a second shot.

For sniper applications, the system must be small and low power. Referring to FIG. 1a, commercially available visible-infrared television cameras can be as small as 4 cubic inches and consume only a few Watts during the short interval when the target is being identified and the rifle aimed and fired.

FIG. 1b is a schematic diagram of another automatically adjustable gun sight system. In contrast to the system of FIG. 1a, in FIG. 1b, the miss-offset information is an input to a fire control system of a remotely pointed trunnion mounted gun/cannon firing supersonic ammunition. In FIG. 1b, a target may be designated by the spotting scope's cross hair and the information corresponding to the target site is fed to a fire control computer system 202 which controls the firing of a gun (which may be mounted on a tank) having a gun barrel (tube) 204. In this embodiment, a first shot fired by the gun 10a would be observed by the scope, digital camera and image processor of 100a. Based on the observed “miss-distance” between the target and the impact point, the processor 104a provides aim adjustment to the fire control computer system 202 causing the gun's position in the x and/or y direction to be changed for the next round. Thus, in this application, the error offset information would be an input to a fire control computer to adjust the azimuth and elevation of the trunnion (mechanically mounted-) pointed gun tube to compensate for the miss distance of the previous shot.

In FIG. 1b, the trunnion and fire control computer 202 replace the sniper in aiming the tank gun tube at the target designated by the spotting scope's crosshair. Thus, in the tank gun case, the invention includes the detection of the supersonic round's trace and measurement of the miss-distance and using the miss-distance information as an input to the fire control computer.

In contrast, in the sniper pointed rifle case of FIG. 1a, the invention includes: (a) trace based measurement of miss-distance; and (b) automatically changing the reticle's position to change the boresight of the rifle to its telescopic sight to dynamically correct for the miss distance under the given circumstances.

In both FIGS. 1a and 1b, which are schematic block diagrams of systems embodying the invention, images of the atmospheric turbulence created by supersonic velocity bullets referred to by the sniper community as the in-flight bullet's “trace”, are acquired by a television camera sharing the spotting scope with a Spotter. These images are digitized and analyzed by a digital image processor to detect the “trace” of a bullet and determine its position (offset) relative to the spotting scope's crosshair position centered on the image of the sniper's target. In the case of the rifle, this offset information is transmitted (sent) to the rifle telescope's reticle module to shift its reticle position such that the rifle's aim of the next shot is shifted to account for any miss-distance errors causing the first shot to miss its target. In the case of a gun (mounted for example on a tank), the offset information is transmitted (sent) to the gun's position control so that the gun's aim of the next shot is shifted to account for any miss-distance errors causing the first shot to miss its target.

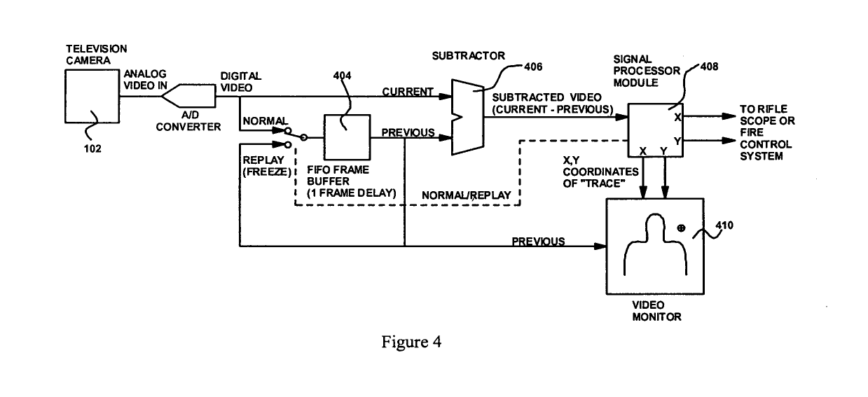

FIG. 4 is a block diagram which includes a video image processor electronics module that can compare successive frames, in real time, to detect changes that indicate the location of the bullet “trace” relative to the crosshair, and output this information to make appropriate changes to the position of the crosshair in the rifle's telescopic sight. These electronics can be combined with the television camera in a package size of about 3×3×4 inches, including battery and attached to the spotting scope.

Referring to FIG. 4, the incoming video signal from the television camera 102 is digitized and stored in a FIFO (First In, First Out) frame buffer 404 that provides a 1 frame delay. While a new frame is being written to the FIFO input, the preceding frame is being read line by line from the output to a Subtraction Circuit 406.

The Subtractor Circuit 406 subtracts the previous frame video from the current digital video on a pixel by pixel basis as the input to a signal processor module 408. The Signal Processor Module 408 is programmed to process the subtracted video frame to detect the optical image characteristic of the “trace” (atmospheric disturbance created by the supersonic bullet) and produces X and Y coordinates of the “trace” in the video frame. The X and Y coordinates are superimposed on a video monitor 410 that displays the digitized video scene, and are also output to the rifle scope or fire control system of a remotely aimed gun/cannon.

When the signal processor module outputs the X and Y coordinates of the “trace”, it also sends a signal blocking the video from the camera updating the FIFO, freezing the video frame stored in the FIFO such that it replays the stored frame as input to the video display.

The invention has been described for the case where the trace of the bullet is used to view and/or determine its path. However, as already noted, in systems embodying the invention, the imaging apparatus may be designed to capture images of the bullet itself, in addition to the “trace” of the bullet, or as an alternative to the trace. The captured images may then be processed in a similar manner to the processing of the trace images.

What is claimed is:

1. A combination comprising:
a gun barrel for firing a bullet at very high speed at a target, said bullet producing a trace as it travels from the gun to the target;
a spotter scope for focusing on the target and for viewing at lest one of the trace and travel of a bullet fired from the gun barrel towards the target;
a digital camera coupled to the spotter scope for capturing images of at least one of the bullet and the bullet's trace as it travels towards the target; and
image processing means coupled to the digital camera for receiving the images of at least one of the bullet's travel and the bullet's trace and in response thereto determining and calculating any miss-distance indicated between the captured images of at least one of the bullet's travel and the bullet's trace and the target.

2. A combination as claimed in claim 1, further including means coupled between the image processing means and the gun barrel for controlling the positioning of the gun barrel to reduce the miss-distance of a next shot.

3. A combination as claimed in claim 2, further including a telescopic sight fixedly mounted relative to the gun barrel to aid a gunner in aiming the gun barrel at the target.

4. A combination as claimed in claim 3, further including an adjustable reticle module mounted in said telescopic sight and wherein said image processing means includes means for sending signals to said adjustable reticle module for automatically adjusting its boresighting to improve aiming at the target.

5. A combination as claimed in claim 4, wherein the gun barrel and its telescopic sight are parts of a rifle intended to be operated by a person.

6. A combination as claimed in claim 2, wherein the gun barrel is part of a gun mounted on a tank.

7. A combination as claimed in claim 1, further including means for selectively viewing different television image frames of at least one of the travel of the bullet and the bullet's trace at it nears the target.

8. A combination as claimed in claim 1, wherein the bullet is fired so it travels at very high speeds and wherein the digital camera captures images of the atmospheric perturbations created by a bullet traveling at very high speeds, also referred to herein as the trace of the bullet, as the bullet travels towards the target.

9. A combination as claimed in claim 1, further including image display means coupled to the image processor for displaying to a viewer the calculated position of the bullet trace relative to the spotting scope crosshair designating target as the bullet nears the target.

10. A method for aiming bullets fired from a gun barrel at supersonic velocity, comprising the steps of:
attaching a digital camera to a spotting scope aimed at a target and for viewing through the scope the trace of a bullet aimed at the target; where said digital camera includes means of producing a digitized video output;
feeding the camera's digitized video output to an image-processor;
processing the digitized images in the image processor, in near real time, to identify the “trace” image and determine its location relative to the aim point to calculate any offset between the two; and
using the information corresponding to the calculated offset to aid in re-aiming the gun barrel for a next shot.

11. A method as claimed in claim 10, wherein said gun barrel is part of a rifle having a telescopic sight which includes an adjustable reticle and actuators which control the adjustable reticle module in the rifle's telescopic sight; and
wherein the step of using the information corresponding to the calculated offset to aid in re-aiming the gun barrel for a next shot includes activating the actuators to shift the position (X,Y) of the telescopic sight reticle to automatically change the boresight of the telescopic sight relative to rifle barrel/bore.

12. A method as claimed in claim 10, wherein said gun barrel is part of a gun mounted on a tank.

13. A combination comprising:
a gun barrel for firing a bullet at a target;
a telescopic sight including an adjustable reticle module coupled to said gun barrel for aiming a bullet at said target;
a spotter scope for focusing on the target and for viewing the travel of a bullet fired from the gun barrel towards the target;
a digital camera coupled to the spotter scope for capturing images of the bullet as it travels towards the target; and
image processing means coupled to the digital camera for receiving the images of the bullet's travel and in response thereto determining and calculating any miss-distance indicated between the captured images of the bullet's travel and the target.

14. A combination as claimed in claim 13 wherein said image processing means further includes means for sending signals to said adjustable reticle module for automatically adjusting its aiming position of the target.

15. A combination as claimed in claim 13 wherein said spotter scope is fixedly mounted to view the bullet trace.
